(19) United States
(12) Patent Application Publication
(10) Pub. No.: US 2002/0001784 A1
(43) Pub. Date: Jan. 3, 2002

(54) Silver halide photographic emulsion

(76) Inventor: Masashi Shirata, Kanagawa (JP)

Correspondence Address: SUGHRUE, MION, ZINN, MACPEAK & SEAS, PLLC, 2100 Pennsylvania Avenue, N.W., Washington, DC, 20037, US

(21) Appl. No.: 09/815,013

(22) Filed: Mar. 23, 2001

(30) Foreign Application Priority Data
Mar. 23, 2000 (JP) P.2000-082472

(51) Int. Cl. G03C 1/035; G03C 1/16; G03C 1/18; G03C 1/20

(52) U.S. Cl. 430/567; 430/583; 430/584; 430/588; 430/569

(57) ABSTRACT

A silver halide emulsion is disclosed, comprising silver halide grains of which 70% or more of the total projected area is occupied by tabular grains, said tabular grain having main surfaces of {111} face and a thickness of 0.04 μm or less and being joined with an epitaxial phase comprising silver halide containing 97 mol % or more of silver iodide.

### FIELD OF THE INVENTION

The present invention relates to a light-sensitive silver halide emulsion, more specifically, the present invention relates to a silver halide tabular grain emulsion.

### BACKGROUND OF THE INVENTION

In general, a silver halide tabular grain (hereinafter referred to as a “tabular grain”) has the following advantageous points particularly in the case of a silver halide emulsion having a small thickness.

1) The ratio of the surface area to the volume (hereinafter referred to as a “specific surface area”) is large and a large amount of sensitizing dye can be adsorbed to the surface, so that the sensitivity to color sensitization can be high based on the specific sensitivity.

2) When an emulsion containing tabular grains is coated and dried, the grains are orientated in parallel on the support surface, so that the coated layer can be reduced in the thickness and the photographic light-sensitive material using the emulsion can have good sharpness.

3) The light scattering is reduced, so that an image having high resolution can be obtained.

4) The sensitivity to blue light is low, so that when the tabular grain is used in a green-sensitive layer or a red-sensitive layer, an yellow filter can be removed from the emulsion layer.

By virtue of these, the tabular grain has been heretofore used in high-sensitivity light-sensitive materials available on the market. JP-B-6-44132 (the term “JP-B” as used herein means an “examined Japanese patent publication”) and JP-B-5-16015 disclose a tabular grain emulsion having an aspect ratio of 8 or more. The “aspect ratio” as used herein means a ratio of the diameter to the thickness of a grain. The “diameter of a grain” indicates a diameter of a face having an area equal to the projected area of a grain when the emulsion grain is observed through a microscope or an electron microscope. The “thickness” is a distance between two parallel faces constituting a tabular silver halide.

JP-B-4-36374 describes a color photographic light-sensitive material in which tabular grains having a thickness of less than 0.3 μm and a diameter of 0.6 μm or more are used in at least one of a green-sensitive emulsion layer and a red-sensitive emulsion layer and thereby, the sharpness, sensitivity and graininess are improved. However, in recent years, silver halide light-sensitive materials are directed to higher sensitivity and smaller formatting and a color light-sensitive material having higher sensitivity and more improved in the image quality is keenly demanded. To cope with this, the silver halide emulsion is also required to have higher sensitivity and more excellent graininess. However, conventional tabular silver halide emulsions cannot satisfy these requirements and more improvements are demanded in the capability.

As the aspect ratio of the tabular grain is larger, the specific surface area can be more increased and the above-described advantageous points of the tabular grain can be more fully utilized. That is, the thin tabular grains which are decreased in thickness are required for realizing a high aspect ratio.

However, tabular grains having a thickness of 0.4 μm or less (ultrathin tabular grains) are disadvantageous in that although a larger amount of sensitizing dye can be adsorbed, the incident light is in turn more reflected and the expected increase of the light absorption can be hardly obtained. Furthermore, the emulsion grains coagulate and thereby the photographic properties deteriorate.

On the other hand, silver iodide exhibits a face-centered cubic crystal lattice structure only at a very high pressure level (from 3,000 to 4,000 times the atmospheric pressure). The silver iodide in this form is called 6 phase silver iodide and not relevant to the silver halide photographic technology. The most stable silver iodide crystal structure is a hexagonal wurtzite generally called β phase silver iodide. The next silver iodide crystal lattice structure which is satisfactorily stable and photographically useful is silver iodide having a face-centered cubic zinc-blende crystal structure, which is called γ phase silver iodide. Silver iodide emulsions containing a β phase crystal structure, a γ phase crystal structure of a mixture of these phases are produced at present. The fourth crystallographic morphology of silver iodide is a phase, namely, a body-centered cubic crystal structure and in James, The Theory of Photographic Process, page 1, supra, it is stated that a temperature of 146° C. is necessary for the production of this phase. The “bright yellow” silver iodide reported in Daubendiek, U.S. Pat. No. 4,672,026 is believed to be actually a phase silver iodide (pages 1 to 5 of James are related to this and also to the portion after this discussion).

A high iodide silver halide grain exhibits higher specific absorption in the blue region having a short spectrum (400 to 450 nm) and in this point, the high iodide silver halide grain is outstandingly superior to the face-centered cubic crystal structure silver halide grain. In particular, the high iodide silver halide is identified as a grain which shows an absorption peak at 425 nm not appearing in the spectrum of silver chloride or silver bromide, does not exhibits a face-centered cubic crystal structure and generally contains in the silver iodide crystal lattice structure, 97 mol % or more of iodide based on the total amount of silver (hereinafter referred to as “high iodide”), in other words, contains only a slight amount of bromide and/or chloride. Maternaghan, U.S. Pat. No. 4,184,878 describes an actual example of the high iodide silver halide emulsion.

However, the high iodide silver halide grain is difficult to sensitize and develop with a commercially available developer and this difficulty greatly inhibits the use of this grain as a latent image-forming silver halide grain.

To overcome this problem, it has been proposed on occasions to join a high iodide phase to the surface of a silver halide tabular grain having a face-centered hexagonal crystal lattice structure with an attempt to realize both the advantageous points of the tabular grain and the high light absorption of the silver iodide at the same time and compensate for their respective defects.

U.S. Pat. No. 4,471,050 discloses a technique which can selectively adsorb non-isomorphous silver salts to the edge of a silver halide host grain while not relying on an additional site directing moiety. Examples of the non-isomorphous include silver thiocyanate, β phase silver iodide (this exhibits a hexagonal wurtzite crystal structure), γ phase silver iodide (this exhibits a zinc blend type crystal structure), silver phosphate (including metaphosphate and pyrophosphate), and silver carbonate. These non-isomorphous silver salts all do not exhibit a face-centered cubic crystal structure of the type shown in photographic silver halides (namely, a rock salt-type isomorphous face-centered cubic crystal structure). In practice, the elevation of sensitivity brought about by the non-isomorphous silver salt epitaxy is smaller than the increment gained by the comparative isomorphous silver salt epitaxial sensitization.

JP-A-8-171162 (the term “JP-A” as used herein means an “unexamined published Japanese patent application”) discloses a silver halide emulsion containing a protrusion epitaxially joined to the peripheral edge part of a {111} ultrathin tabular grain, where the protrusion has an iodide concentration higher than that of the tabular grain. The ultrathin tabular grain reduces the scattering of visible light and realizes low-level granularity. However, since the protrusion has a face-centered cubic crystal lattice structure isomorphous to the tabular grain, the iodide content is limited and additionally, conversion takes place with the halogen constituting the tabular grain, so that the effect as silver iodide cannot be provided.

JP-A-2000-2959 discloses a silver halide tabular grain where a ruffle surface consisting of fine protrusions containing 10 mol % or less of iodide and having a projected area diameter of 0.15 μm or less is formed on the main surface of the {111} tabular grain. In this invention, the specific surface area is increased without reducing the thickness of the tabular grain and therefore, a tabular silver halide grain increased in the amount of dye adsorbed and reduced in the light reflection can be provided. However, the purpose of incorporating silver iodide into the protrusion is not to improve the light absorption but to maintain the shape stability of the protrusion and the photographically useful properties of the silver iodide, such as light absorption with high efficiency, are not fully brought out.

U.S. Pat. No. 5,604,086 discloses an example of the emulsion comprising a high iodide silver halide grain obtained after epitaxial growth on the main surface of a tabular grain having a rock salt-type face-centered cubic lattice structure. This is a composite grain having a high iodide content epitaxial phase on the main surface of a {111} or {100} tabular grain and the high iodide epitaxial phase of the grain forms a triangular or hexagonal face shape. It is stated that this high iodide phase greatly increases the blue light absorption. However, this emulsion still has problems in that the epitaxial phase non-uniformly deposits among grains, the iodide content of the epitaxial phase is relatively low because halogen conversion takes place between the host tabular grain and the epitaxial phase, and the image sharpness is low because the host tabular grains used contain relatively thick grains.

### SUMMARY OF THE INVENTION

The object of the present invention is to achieve a high image formation efficiency by making use of the short wave blue absorption of a high iodide phase while maintaining excellent development characteristics of a silver halide grain having a face-centered cubic lattice structure.

According to the present invention, an ideally high iodide epitaxy is disposed on the main surface of an ultrathin tabular grain and thereby, a composite grain structure ensuring respective general improvements of both the iodide and the tabular grain is produced.

The object of the present invention can be attained by the following matters.

(1) A silver halide emulsion comprising silver halide grains of which 70% or more of the total projected area is occupied by tabular grains, said tabular grain having main surfaces of {111} face and a thickness of 0.04 μm or less and being joined with an epitaxial phase comprising silver halide containing 97 mol % or more of silver iodide.

(2) The silver halide emulsion as described in (1), wherein at least 60% of said epitaxial phase contains 97 mol % or more of silver iodide.

(3) The silver halide emulsion as described (1) or (2), wherein said epitaxial phase occupies at least 10% of the total silver amount.

(4) The silver halide emulsion as described in any one of (1) to (3), wherein the area occupied by the epitaxial phase joined to the main surface of said tabular grain is within ±10% of the average occupation area in all grains.

(5) The silver halide emulsion as described in any one of (1) to (4), wherein said tabular grain has an equivalent-circle diameter of at least 0.7 μm.

(6) The silver halide emulsion as described in any one of (1) to (5), wherein the coefficient of variation in the thickness of said tabular grains is less than 40% among grains.

(7) The silver halide emulsion as described in any one of (1) to (6), wherein [1] said tabular grain comprises core and shell, [2] the shell contains one or more dislocation line starting from the interface between core and shell and reaching the edge or corner of the tabular grain, and [3] the amount of silver used for the formation of core is from 0.1 to 10% of the entire amount of silver used for forming the grain.

(8) The silver halide emulsion as described in any one of (1) to (7), wherein said tabular grain comprises at least 50 mol % of silver chloride.

(9) The silver halide emulsion as described in any one of (1) to (7), wherein said tabular grain comprises at least 70 mol % of silver bromide.

(10) The silver halide emulsion as described in any one of (1) to (9), wherein in the preparation of said tabular grains, at least one compound represented by formula (I), (II) or (III) is absent at the nucleation but is present at the ripening and growing:

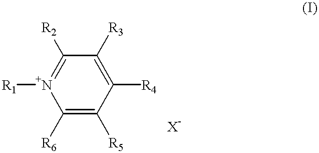

(wherein R₁ represents an alkyl group, an alkenyl group or an aralkyl group, R₂, R₃, R₄, R₅ and R₆ each represents a hydrogen atom or a substituent, each pair R₂ and R₃, R₃ and R₄, R₄ and R₅, and R₅ and R₆ may form a condensed ring, provided that at least one of R₂, R₃, R₄, R₅ and R₆ represents an aryl group, and X⁻ represents an anion);

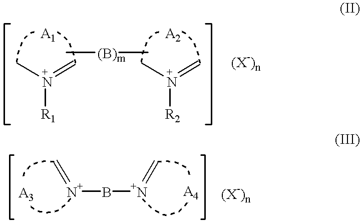

wherein A₁, A₂, A₃ and A₄, which may be the same or different, each represents a nonmetallic atom group necessary for completing a nitrogen-containing heterocyclic ring, B represents a divalent linking group, m represents 0 or 1, R₁ and R₂ each represents an alkyl group, n represents 0, 1 or 2, and X⁻ represents an anion.

(11) The silver halide emulsion as described in any one of (1) to (10), wherein said tabular grains are formed by providing a mixing vessel outside a reactor in which nucleation and/or grain growth of said tabular grains takes place, feeding an aqueous solution of an aqueous silver salt and an aqueous solution of aqueous halide into said mixing vessel to form silver halide fine grains, and immediately feeding the formed fine grains into said reactor to cause nucleation and/or grain growth of silver halide grains in the reactor.

(12) The silver halide emulsion as described in any one of (1) to (11), wherein said silver halide grain is spectrally sensitized by a dye represented by formula (S):

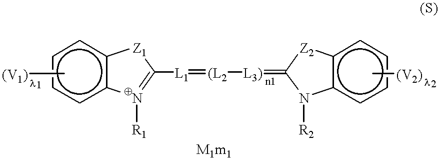

wherein Z₁ and Z₂ each represents a sulfur atom, a selenium atom, an oxygen atom or a nitrogen atom, V₁ and V₂ each represents a monovalent substituent, provided that V₁ and V₂ each is not combined with an aromatic group to form a condensed ring or two or more adjacent substituents V₁ or V₂ are not combined to form a condensed ring, λ₁ and λ₂ each represents 0, 1, 2 or 3, L₁, L₂ and L₃ each represents a methine group, R₁ and R₂ each represents an alkyl group, n₁ represents 0, 1 or 2, m represents a number of 0 or more necessary for neutralizing the electric charge of the molecule, and M₁ represents a charge balancing counter ion.

### DETAILED DESCRIPTION OF THE INVENTION

In the present invention, the silver halide grain comprises a host tabular grain and an epitaxial phase present on the main surface of the host tabular grain.

The host tabular grain of the present invention suitably has a diameter (equivalent-circle diameter) of 0.7 μm or more (preferably 5 μm or less), preferably 0.9 to 4.5 μm, more preferably from 1.2 to 4 μm, and the deviation thereof is preferably within 30%, more preferably within 20%. The grain thickness is 0.04 μm or less, preferably from 0.03 to 0.01 μm. In the present invention, the grain diameter and the grain thickness can be determined from an electron microphotograph of the grain as in the method described in U.S. Pat. No. 4,434,226.

The host tabular grain for use in the present invention has a main surface of {111} face. Silver halide grains having one twin plane or two or more parallel twin planes are generically called a tabular grain having a main surface of {111} face. The twin plane means a {111} face when ions at all lattice points on both sides of this {111} face are in the mirror image relation. When viewed from above, this tabular grain has a triangular or hexagonal shape or a rounded shape thereof. The triangular, hexagonal or rounded tabular grain has triangular, hexagonal or rounded outer surfaces in parallel with each other, respectively.

The host tabular grain of the present invention has a halogen composition of silver iodobromide, silver chloroiodobromide, silver bromide or silver chloride. The halogen composition preferably contains at least 50 mol % of silver chloride or at least 70 mol % of silver bromide. The halogen composition may be homogenous or may form a core-shell type structure. In the core-shell structure grain, the iodide content may be high in the core part and low in the shell part or may be low in the core part and high in the shell part. The boundary between different halogen compositions may be clear or may be unclear due to the presence of a mixed crystal formed by the different compositions. Also, a continuous structural change may be intentionally provided at the boundary. The structure relating to the halogen composition of the host tabular grain for use in the present invention can be confirmed by combining X-ray diffraction, EPMA (sometimes called XMA) method (a method of scanning a silver halide grain by an electron beam and thereby detecting the silver halide composition), ESCA (a method of irradiating an X ray and spectrally separating photoelectrons coming out from the grain surface) and the like. In the present invention, the grain surface means the region from the surface to the depth of about 50 Å and the halogen composition in this region can be usually measured by ESCA method. The grain inside means the region other than the above-described surface region.

The production method and use technique of the {111} main surface-type tabular grain which is the host tabular grain for use in the present invention are disclosed in U.S. Pat. Nos. 4,434,226, 4,439,520, 4,414,310, 4,433,048, 4,414,306 and 4,459,353. In addition, as disclosed in JP-A-6-214331, after once obtaining a seed crystal emulsion by the nucleation, silver and a halogen solution may be added to grow the grains by setting the conditions such as pH and pAg to be suitable for the growth, thereby forming tabular grains.

The host tabular grain for use in the present invention is preferably monodisperse tabular grains. With respect to the monodisperse tabular grains, JP-A-63-11928 and JP-B-5-61205 disclose monodisperse hexagonal tabular grains and JP-A-1-131541 discloses monodisperse circular tabular grains. Also, JP-A-2-838 discloses an emulsion where 95% or more of the entire projected area is occupied by tabular grains having two parallel twin planes as the main surface and the size distribution of the tabular grains is monodisperse, and EP-A-514742 discloses a tabular grain emulsion where the coefficient of variation in the size of grains prepared using a polyalkylene oxide block copolymer is 10% or less.

The host tabular grain for use in the present invention is preferably prepared by a method of adding silver halide fine grains to the reactor holding a protective colloid aqueous solution in place of adding an aqueous silver salt solution and an aqueous halide solution, and thereby performing the nucleation and/or growth. The technique of this method is disclosed in U.S. Pat. No. 4,879,208, JP-A-1-183644, JP-A-2-4435, JP-A-2-43535 and JP-A-2-68538. For feeding iodide ion in the formation of tabular grains, a fine grain silver iodide (grain size is 0.1 μm or less, preferably 0.06 μm or less) emulsion may be added and in this case, the silver iodide fine grains are preferably fed using the production method disclosed in U.S. Pat. No. 4,879,208. In the method of adding fine grains and performing the nucleation and/or grain growth, the silver halide grains are preferably adjusted by preparing silver halide fine grains in a stirring tank while rotation-driving a stirring blade having no rotation shaft passing through the stirring tank and adding the silver halide fine grains to the reactor.

In forming {111} main surface tabular grains as the host tabular grain for use in the present invention, a compound represented by formula (I), (II) or (III) is preferably used.

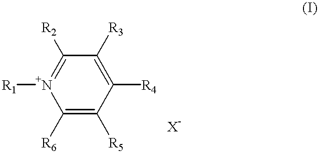

(wherein R₁ represents an alkyl group, an alkenyl group or an aralkyl group, R₂, R₃, R₄, R₅ and R₆ each represents a hydrogen atom or a substituent, each pair R₂ and R₃, R₃ and R₄, R₄ and R₅, and R₅ and R₆ may form a condensed ring, provided that at least one of R₂, R₃, R₄, R₅ and R₆ represents an aryl group , and X⁻ represents anion)

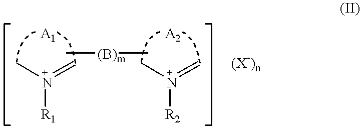

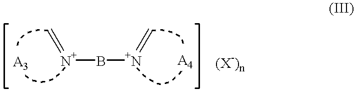

(wherein A₁, A₂, A₃ and A₄, which may be the same or different, each represents a nonmetallic atom group necessary for completing a nitrogen-containing heterocyclic ring, B represents a divalent linking group, m represents 0 or 1, R₁ and R₂ each represents an alkyl group, n represents 0, 1 or 2, provided that when an inner salt is formed, n is 0, and X⁻ represents an anion).

In a preferred embodiment of formula (I), R₁ represents an aralkyl group, R₄ represents an aryl group and X⁻ represents a halide ion. Examples of this compound include Crystal Habit Control Agents 1 to 29 of EP 723187A, however, the compound used in the preparation of the host tabular grain for use in the present invention is not limited thereto. Specific examples of the compound represented by formula (II) or (III) include those (Compounds 1 to 42) disclosed in JP-A-2-274300, however, the compound used in the preparation of the host tabular grain for use in the present invention is not limited thereto.

The extremely ultrathin tabular grain having a thickness of 0.04 μm or less has a larger specific surface area and thereby, can adsorb a larger amount of sensitizing dye per one grain and furthermore, the epitaxial phase contains high iodide and therefore, absorbs a large amount of blue light per one grain, whereby high sensitivity can be achieved. On the other hand, as described in JP-A-6-43605 and JP-A-6-43606, if the thickness of the tabular grain is less than 0.1 μm, the incident light is more intensely reflected on the main surface of tabular grains oriented perpendicularly to the incident light, as a result, the effect of increasing the specific surface area and allowing a larger amount of sensitizing dye to adsorb by reducing the thickness of a tabular grain is decreased. Therefore, it is disclosed not to use an ultrathin tabular grain of 0.04 μm or less but to use a tabular grain emulsion having an aspect ratio of 10 or more and a thickness of 0.14 to 0.17 μm for the red-sensitive layer, a tabular grain having a thickness of 0.11 to 0.13 μm for the green-sensitive layer and a tabular grain having a thickness of 0.08 to 0.10 μm for the blue-sensitive layer.

In the present invention, means for solving this problem at a stroke is provided. That is, in the present invention, the host tabular grain is an ultrathin tabular grain of 0.04 μm or less having a very large surface area per one grain and by forming a large number of epitaxial phases on the main surface thereof, the specific surface area can be more increased. The above-described increase in the light reflection resulting from the reduction in the thickness of the tabular grain to 0.04 μm or less can be prevented, because a large number of epitaxial phases are formed on the main surface of the tabular grain and the thickness of the tabular grain is substantially increased. The tabular grain for use in the present invention realizes a large increase in the amount of sensitizing dye adsorbed due to the remarkable increase in the specific surface area and at the same time, prevents the increase in the reflected light, whereby the amount of light absorbed per one tabular grain can be outstandingly increased and high sensitivity heretofore not attained can be achieved. The epitaxial phase is not a continuous layer and this is not included in the thickness of a tabular grain, however, the thickness of a tabular grain is undoubtedly increased in a substantial meaning. By virtue of this, the increase of the specific surface area and the reduction in the light reflection can be obtained at the same time.

In the present invention, the epitaxial phase is present on the main surface of a host tabular grain and contains 97 mol % or more of (high) iodide. The silver iodide has high shape stability because of its low solubility and also can gain blue absorption.

The halides other than iodide are resultant from the deposit of epitaxial phases caused when silver ion and iodide ion are introduced into the first tabular grain emulsion in the presence of bromide ion and/or chloride ion in the dispersion medium of the first tabular grain emulsion equilibrated with host tabular grains. In order to attain light absorption with high efficiency, it is effective to prevent the mixing of halides other than iodide, into the epitaxial phase as much as possible. In the present invention, from the similar reasons in the case of halogen composition of the epitaxial phase, 60% of the epitaxial phase must comprise 97 mol % of silver iodide.

In the case of exposing the emulsion of the present invention by short wave light of 400 to 450 nm, the photons are absorbed not only by the tabular grain but also by the epitaxial sites present on the main surface (excluding some cases). This epitaxial phase is present in the upper and lower sides of a tabular grain, therefore, 60 to 70% of all photons of the short wave blue light can be absorbed by the upper and lower epitaxial sites. If the epitaxial sites are present at the fringe or top part of a tabular grain, the photons which can be absorbed are extremely reduced. Therefore, ideally, the epitaxial phase is preferably not formed on the outer side of the main surface.

When a blue-sensitive dye (a dye sensitive to a wavelength of 400 to 500 nm) is applied to a normal tabular grain, a dye having a maximum absorption wavelength in the range from 400 to 500 nm and exhibiting a half-value width of about 100 nm is most preferred. However, actually, almost no dye exhibits a half-value width of 100 nm and no dye has a half-value width in the same expansion as the spectrum wavelength of blue light. The blue-sensitive dye usually has a half-value width of 50 nm or less. When one or more dye having a maximum absorption in the long wavelength region is combined with the emulsion of the present invention, since the absorption peak of the epitaxial phase is 427 nm, the entire blue portion in the spectrum is surpassed and blue absorption can be obtained with higher efficiency.

In the case of using no light-sensitive dye, the short wave blue photons are absorbed by the epitaxial sites and a pair of photohole and photoelectron is formed. The photoelectron passes through the junction surface between the host tabular grain and the epitaxial phase and freely moves to the host tabular grain On the other hand, the photohole is trapped within the epitaxial site. By this separation of photoelectron from photohole, their recombination is inhibited. As such, the epitaxial phase contributes to the holding of a large number of photoelectrons and as a result, can act to elevate the sensitivity of the emulsion grain as a whole.

In the emulsion of the present invention, whatever sensitizing dye is used, the sensitivity of the entire emulsion can be elevated by the high iodide epitaxial phase. A longer wave photon is actually absorbed by the sensitizing dye and the dye injects the absorbed energy directly into the epitaxial site or the host tabular grain. The pothole remaining in the dye is trapped within the epitaxial site. This mechanism can be applied irrespective of the exposure conditions and therefore, the epitaxial phase can improve the latent image formation efficiency of an emulsion exposed to the green or red spectrum.

The short wave blue light absorption efficiency can be -improved by increasing the thickness of epitaxy and increasing the occupation area. In order to more improve the light absorption efficiency, the ratio of epitaxy present on the main surface of a host tabular grain is preferably increased and the epitaxy preferably occupies at least 25% or more, preferably 50% or more, ideally 60% ore more, of the main surface.

The area of the epitaxial phase occupying in one grain is preferably within +10%, more preferably within ±8%, of the average occupation area in all grains. With this range, the image sharpness can be more elevated.

It is found that when the host tabular grain of the present invention has a dislocation line within the grain, the effect can be more satisfactorily brought out. The technique of introducing a dislocation line into a silver halide grain under control is described in JP-A-63-220238. According to this patent publication, a specific high iodide phase is provided inside a tabular silver halide grain having an average grain size/grain thickness ratio of 2 or more and a phase having an iodide content lower than that of the high iodide phase covers the outer side of the high iodide phase, whereby dislocation can be introduced. By this introduction of dislocation, effects such as increase in sensitivity, improvement of storability, improvement of latent image stability and reduction in pressure fogging (i.e., pressure marks) can be obtained. In the invention of this patent publication, the dislocation is introduced mainly into the edge part of a tabular grain. Also, U.S. Pat. No. 5,238,796 describes a tabular grain in which dislocation is introduced into the center part. This patent publication states that the dislocation can be introduced by producing an epitaxy of silver chloride or silver chlorobromide on a regular crystal grain and subjecting the epitaxy to physical ripening and/or halogen conversion and that by this introduction of dislocation, effects such as increase in the sensitivity and decrease in pressure fogging (i.e., pressure marks) can be obtained. The dislocation line in a silver halide grain can be observed by a direct method using a transmission electron microscope at a low temperature described, for example, in J. F. Hamilton, Photo. Sci. Eng., 1967, 11, 57, or T. Shiozawa, J. Soc. Photo. Sci. JAPAN, 1972, 35, 213. More specifically, silver halide grains are taken out from an emulsion while taking care not to apply a pressure sufficiently high to generate dislocation, then placed on a mesh for the observation through an electron microscope, and observed by a transmission method while laying the sample in the cooled state so as to prevent damage (printout) by an electron beam. At this time, as the grain thickness is larger, the transmission of an electron beam becomes more difficult and therefore, a high-pressure type (200 keV or more for the thickness of 0.25 μm) electron microscope is preferably used to observe the grains more clearly. From the thus-obtained photograph of grains, the site and the number of dislocation lines of individual grains viewed from the surface perpendicular to the main surface can be determined.

In the case of the tabular grain for use in the present invention, the dislocation is present in the shell part. The dislocation is generated in the boundary between core and shell and extends accompanying the growth of the shell. At this time, the direction of the dislocation extending is linear and may be almost right-angled to the side of the tabular grain, may be linear but not right-angled to the side, or may be curved and almost right-angled or not right-angled to the side. The ratio of the core to the shell having dislocation is not particularly limited as long as the silver amount used for the formation of core is from 0.1 to 10% of the total silver amount used for formation of the grain.

In the present invention, the epitaxial phase contains iodide in a high ratio, so that the solubility thereof is low and the shape is stably maintained. Moreover, by virtue of the presence of iodide ion on the epitaxy surface, the adsorption of the sensitizing dye is intensified.

In the case of a thin tabular grain, due to the small thickness of the grain, aggregation of grains is present as a problem, however, it is found that in the present invention, the aggregation of grains is improved by the deposition of the epitaxial phase.

The formation of a large number of epitaxial phases on the main surface of a host tabular grain as seen in the present invention is considered to be ascribable to the difference in the lattice constant between the grain parent component and the epitaxial phase component. The lattice constant is described, for example, in T. H. James, The Theory of the Photographic Process, 4th ed., pp. 3-4, MacMillan, N. Y. (1977). When the lattice constant of the host tabular grain greatly differs from the lattice constant of the epitaxial phase, it is presumed that the growth in the areal direction of the tabular grain proceeds to an extent such that the distortion of the lattice structure cannot be relaxed, and thereafter or at the same time, the growth proceeds other than the areal direction, as a result, a large number of epitaxial phase are formed on the main surface of the host tabular grain.

In order to form the epitaxial phase of the present invention on the main surface of a host tabular grain, the phase is formed at a silver potential from +60 to +80 mV (with a reference electrode of a saturated calomel electrode), preferably from +70 to +75 mV. The temperature at the formation of protrusions is preferably higher and this is suitably from 50 to 80° C., preferably from 55 to 65° C. The production method is specifically described in Examples but a double jet method at a controlled electric potential is preferred.

At the time of forming the epitaxial phase, the addition rate of AgNO₃ is from 0.1 to 0.7 g/min, preferably from 0.2 to 0.6 g/min.

In the present invention, the epitaxial phase is preferably deposited on the main surface of the host tabular grain but not on the edge part However, in practice, the epitaxial phase is usually deposited on both the outer edge part and the main surface of the host tabular grain.

The silver halide grain for use in the present invention is prepared as a protective colloid. For the gelatin, an alkali treatment is usually used in many cases. In particular, an alkali-treated gelatin subjected to an deionization treatment or an ultrafiltration treatment to remove impurity ion or impurities may be used. In addition to the alkali-treated gelatin, examples of the gelatin which can be used include an acid-treated gelatin, a low molecular gelatin (specific examples of the gelatin having a molecular weight of 1,000 to 80,000 include a gelatin decomposed by an acid, a gelatin hydrolyzed with an acid and/or an alkali, and a gelatin decomposed by heat), a high molecular gelatin (molecular weight: 110,000 to 300,000), a gelatin having a methionine content of 50 μmol.g or less, a gelatin having a tyrosine content of 20 μmol/g or less, an oxidation-treated gelatin reduced in the methionine group, a gelatin containing methionine inactivated by alkylation, and various modified gelatins including phthalated gelatin having a modified amino group, succinated gelatin, trimellited gelatin, pyromellited gelatin, esterified gelatin including methyl esterified gelatin having a modified carboxyl group, and a gelatin having a modified imidazole group, such as amidated gelatin and ethoxyformylated gelatin. These gelatins may be used individually or in combination of two or more thereof. In the present invention, the amount of gelatin used in the grain formation step is from 1 to 60 g/mol-Ag, preferably from 3 to 40 g/mol-Ag. In the present invention, the concentration of gelatin in the chemical sensitization step is preferably from 1 to 100 g/mol-Ag, more preferably from 1 to 70 g/mol-Ag.

Although not essential in the practice of the present invention, a chemical sensitization may be applied to the host tabular grain so as to improve the photographic performance conformable to the advantageous properties described. It is also verified that a chemical sensitizer can be introduced together with the epitaxial phase into an ultrathin host tabular grain of 0.04 μm or less while completely evading the increase in the thickness of the host tabular grain.

In the present invention, the chemical sensitization may be performed using chalcogen sensitization such as sulfur sensitization, selenium sensitization and tellurium sensitization, in combination with either one or both of noble metal sensitization and reduction sensitization.

In the sulfur sensitization, a labile sulfur compound is used and the labile sulfur compounds described in P. Glafkides, Chemie et Physique Photographigue, 5th ed., Paul Montel (1987), and Research Disclosure, Vol. 307, No. 307105 may be used. Specific examples thereof include well-known sulfur compounds such as thiosulfates (e.g., hypo), thioureas (e.g., diphenylthiourea, triethylthiourea, N-ethyl-N′-(4-methyl-2-thiazolyl)thiourea, carboxymethyltrimethylthiourea), thioamides (e.g-, thioacetamide), rhodanines (e.g., diethylrhodanine, 5-benzylidene-N-ethylrhodanine), phosphinesulfides (e.g., trimethylphosphinesulfide), thiohydantoins, 4-oxo-oxazolidine-2-thiones, dipolysulfides (e.g., dimorpholine disulfide, cystine, hexathiocane-thione), mercapto compounds (cysteine), polythionates, and elemental sulfur. Also, an active gelatin may be used.

In the selenium sensitization, a labile selenium compound is used and the labile selenium compounds described in JP-B-43-13489, JP-B-44-15748, JP-A-4-25832, JP-A-4-109240, JP-A-4-271341 and JP-A-5-40324 may be used.

Specific examples thereof include colloidal metal selenium, selenoureas (e.g., N,N-dimethylselenourea, trifluoromethylcarbonyl-trimethylselenourea, acetyltrimethylselenourea), selenoamides (e.g., selenoamide, N,N-diethylphenylselenoamide), phosphine selenides (e.g., triphenylphosphine selenide, pentafluorophenyl-triphenylphosphine selenide), selenophosphates (e.g., tri-p-tolylselenophosphate, tri-n-butylselenophosphate), selenoketones (e.g., selenobenzophenone), isocyanates, selenocarboxylic acids, selenoesters and diacyl selenides. In addition, non-labile selenium compounds described in JP-B-46-4553 and JP-B-52-34492, such as selenious acid, potassium selenocyanate, selenazoles and selenides, may also be used.

In the tellurium sensitization, a labile tellurium compound is used and the labile tellurium compounds described in Canadian Patent 800,958, British Patents 1,295,462 and 1,396,696, JP-A-4-204640, JP-A-4-271341, JP-A-4-333043 and JP-A-5-303157 may be used. Specific examples thereof include telluroureas (e.g., tetramethyltellurourea, N,N′-dimethylethylenetellurourea, N,N′-diphenylethylenetellurourea), phosphine tellurides (e.g., butyldiisopropylphosphine telluride, tributylphosphine telluride, tributoxyphosphine telluride, ethoxydiphenylphophine telluride), diacyl (di)tellurides (e.g., bis(diphenylcarbamoyl) ditelluride, bis(N-phenyl-N-methylcarbamoyl) ditelluride, bis(N-phenyl-N-methylcarbamoyl) telluride, bis(ethoxycarbonyl) telluride), isotellurocyanates, telluroamides, tellurohydrazides, telluroesters (e.g., butylhexyltelluroester), telluroketones (e.g., telluroacetophenone), colloidal tellurium, (di) tellurides and other tellurium compounds (e.g., potassium telluride, sodium telluropentathionate).

In the noble metal sensitization, salts of noble metals such as gold, platinum, palladium and iridium, may be used and these are described in P. Glafkides, Chemie et Phisigue Photographigue, 5th ed., Paul Montel (1987) and Research Disclosure, Vol. 307, No. 307105. Among these, gold sensitization is preferred. Specific examples of the gold sensitizer which can be used include chloroauric acid, potassium chloroaurate, potassium aurithiocyanate, gold sulfide, gold selenide, and gold compounds described in U.S. Pat. Nos. 2,642,361, 5,049,484 and 5,049,485. In the reduction sensitization, well-known reducing compounds described in P. Glafkides, Chemie et Phisigue Photographigue, 5th ed., Paul Montel, (1987), and Research Disclosure, Vol. 307, No. 307105 may be used. Specific examples thereof include aminoiminomethanesulfinic acid (also called thiourea dioxide), borane compounds (e.g., dimethylaminoborane), hydrazine compounds (e.g., hydrazine, p-tolylhydrazine), polyamine compounds (e.g., diethylenetriamine, triethylenetetramine), stannous chloride, silane compounds, reductones (e.g., ascorbic acid), sulfites, aldehyde compounds and hydrogen gas. The reduction sensitization may also be performed in an atmosphere of high pH or excess silver ion (so-called silver ripening).

These chemical sensitization treatments may be used individually or in combination of two or more thereof and when these are used in combination, a combination of chalcogen sensitization and gold sensitization is preferred. The reduction sensitization is preferably applied at the time of forming silver halide grains. The amount of the chalcogen sensitizer for use in the present invention varies depending on the silver halide grain and chemical sensitization conditions used, however, the amount of the chalcogen sensitizer used is approximately from 10⁻⁸ to 10⁻² mol, preferably from 10⁻⁷ to 5×10⁻³ mol, per mol of silver halide. The noble metal sensitizer for use in the present invention is used in an amount of approximately from 10⁻⁷ to 10⁻² mol per mol of silver halide. The conditions for chemical sensitization are not particularly limited, however, the pAg is generally from 6 to 11, preferably from 7 to 10, the pH is preferably from 4 to 10, and the temperature is preferably from 40 to 95° C., more preferably from 45 to 85° C.

The silver halide emulsion preferably contains various compounds for the purpose of preventing fogging during the preparation, storage or photographic processing of the light-sensitive material or for stabilizing the photographic capabilities. Examples of these compounds include azoles (e.g., benzothiazolium salts, nitroimidazoles, triazoles, benzotriazoles, benzimidazoles (particularly nitro- or halogen-substitution products)), heterocyclic mercapto compound imidazoles (e.g., mercaptothiazoles, mercaptobenzothiazoles, mercaptobenzimidazoles, mercaptothiadiazoles, mercaptotetrazoles (particularly 1-phenyl-5-mercaptotetrazole) and mercaptopyrimidines), the above-described heterocyclic mercapto compounds having a water-soluble group such as a carboxyl group or a sulfone group, thioketo compounds (e.g., oxazolinethione), azaindenes (e.g., tetraazaindenes (particularly 4-hydroxy-substituted (1,3,3a,7)tetraazaindenes), benzenethiosulfonic acids and benzenesulfinic acids. These compounds are generally known as an antifoggant or a stabilizer.

The antifoggant or stabilizer is usually added after the application of chemical sensitization, however, the time of adding the antifoggant or stabilizer may be selected from the period during the chemical sensitization and the period before initiating the chemical sensitization. More specifically, in the process of forming silver halide grains, the antifoggant or stabilizer may be added during the addition of a silver salt solution, in the period from the addition until the initiation of chemical sensitization, or during the chemical sensitization (within the chemical sensitization time, preferably within a time from the initiation until 50%, more preferably until 20%).

The spectral sensitizing dye represented by formula (S) for use in the present invention is described below. In formula (S), Z₁ and Z₂ each represents a sulfur atom, a selenium atom, an oxygen atom or a nitrogen atom. At least one of Z₁ and Z₂ is preferably a sulfur atom. With respect to the spectral sensitizing dye, the compounds described in JP-A-29156/2000 may be referred to.

V₁ and V₂ each represents a monovalent substituent, however, V₁ and V₂ each is not combined with an aryl group to form a condensed ring or two or more adjacent substituents V₁ or V₂ are not combined to form a condensed ring. λ₁ and λ₂ each represents 0, 1, 2, 3 or 4, R₁ and R₂ each represents an alkyl group, L₁, L₂ and L₃ each represents a methine group, n₁ represents 0, 1 or 2, M₁ represents an electric charge balancing counter ion, and m₁ represents a number of 0 or more necessary for neutralizing the electric charge of the molecule.

In formula (S), when n₁ is 0, at least one of Z₁ and Z₂ is a sulfur atom.

In formula (S), when n₁ is 0, Z₁ and Z₂ both are a sulfur atom.

In formula (S), when n₁ is 1, at least one of Z₁ and Z₂ is an oxygen atom.

In formula (S), when n₁ is 1, Z₁ and Z₂ both are an oxygen atom.

In formula (S), when n₁ is 2, Z₁ and Z₂ both are a sulfur atom.

The layer structure of the silver halide photographic material is not particularly limited. However, in the case of a color photographic material, a multi-layer structure is used so as to separately record blue light, green light and red light. Each silver halide emulsion layer may consist of two layers of high-sensitivity layer and low-sensitivity layer. Examples of the layer structure in practice include the followings (1) to (6).

(1) BH/BL/GH/GL/RH/RL/S

(2) BH/BM/BL/GH/GM/GL/RH/RM/RL/S

(3) BH/BL/GH/RH/GL/RL/S

(4) BH/GH/RH/BL/GL/RL/S

(5) BH/BL/CL/GH/GL/RH/RL/S

(6) BH/BL/GH/GL/CL/RH/RL/S

In these layer arrangements, B denotes a blue-sensitive layer, G denotes a green-sensitive layer, R denotes a red-sensitive layer, H denotes a highest-speed layer, M denotes a medium-speed layer, L denotes a low-speed layer, S denotes a support and CL denotes an interlayer effect-imparting layer. Light-insensitive layers such as protective layer, filter layer, interlayer, antihalation layer and subbing layer are omitted. Within the same color sensitivity layer, the high-speed layer and the low-speed layer may be reversed. The arrangement (3) is described in U.S. Pat. No. 4,184,876, (4) is described in Research Disclosure, Vol. 225, No. 22534, JP-A-59-177551 and JP-A-59-177552, and (5) and (6) are described in JP-A-61-34541. Of these, preferred are layer arrangements (1), (2) and (4). The silver halide photographic material of the present invention can be similarly applied to X-ray light-sensitive material, black-and-white light-sensitive material for camera work, light-sensitive material for photomechanical process, and printing paper, in addition to the color photographic material.

Various additives (e.g., binder, chemical sensitizer, spectral sensitizer, stabilizer, gelatin, hardening agent, surfactant, antistatic agent, polymer latex, matting agent, color coupler, ultraviolet absorbent, discoloration inhibitor, dyestuff) for the silver halide emulsion, the support for the photographic material, and the processing method (e.g., coating method, exposure method, development method) of the photographic material are described in Research Disclosure, Vol. 176, No. 17643 (RD-17643), ibid., Vol. 187, No. 18716 (RD-18716), and ibid., Vol. 225, No. 22534 (RD-22534). The pertinent portions in these Research Disclosures are summarized below.

| | Kinds of | | | |
|---|---|---|---|---|
| | Additives | RD-17643 | RD-18716 | RD-22534 |
| 1. | Chemical | p. 23 | p. 648, right | p. 24 |
| | sensitizer | | col. | |
| 2. | Sensitivity | | ″ | |
| | increasing agent | | | |
| 3. | Spectral | pp. 23-24 | p. 648, right | pp. 24-28 |
| | sensitizer, | | col. to p. 649, | |
| | supersensitizer | | right col. | |
| 4. | Brightening agent | p. 24 | | |
| 5. | Antifoggant, | pp. 23-25 | p. 649, right | p. 24 and |
| | stabilizer | | col. | p. 31 |
| 6. | Light absorbant, | pp. 25‥26 | p. 649, right | |
| | filter dye, UV | | col. to p. 650, | |
| | absorbant | | left col. | |
| 7. | Stain inhibitor | p. 25 | p. 650, left to | |
| | | right col. | right cols. | |
| 8. | Dye Image | p. 25 | | p. 32 |
| | Stabilizer | | | |
| 9. | Hardening agent | p. 26 | p. 651, left | p. 32 |
| | | | col. | |
| 10. | Binder | p. 26 | ″ | p. 28 |
| 11. | Plasticizer, | p. 27 | p. 650, right | |
| | lubricant | | col. | |
| 12. | Coating aid, | pp. 26-27 | ″ | |
| | surfactant | | | |
| 13. | Antistatic agent | p. 27 | ″ | |
| 14. | Color coupler | p. 25 | p. 648 | p. 31 |

As the gelatin hardening agent, for example, active halide compounds (e.g., 2,4-dichloro-6-hydroxy-1,3,5-triazine, a sodium salt thereof) and active vinyl compounds (e.g., 1,3-bisvinylsulfonyl-2-propanol, 1,2-bis(vinylsulfonylacetamido)ethane, vinyl polymers having a vinylsulfonyl group on the main chain) are preferred because hydrophilic colloid such as gelatin can be rapidly hardened and stable photographic properties are obtained. Also, N-carbamoyl pyridinium salts (e.g., (1-morpholinocarbonyl-3-pyridinio)methanesulfonate) and haloamidinium salts (e.g., 1-(1-chloro-1-pyridinomethylene)pyrrolidinium 2-naphthalene sulfonate) are preferred because of high hardening rate.

The color photographic material can be developed by an ordinary method described in Research Disclosure, Vol. 176, No. 17643, and ibid., Vol. 187, No. 18716. The color photographic light-sensitive material is usually subjected to a water washing treatment or a treatment with a stabilizer after the bleach-fixing or fixing treatment. The water washing is generally performed in a countercurrent washing system using two or more tanks for the purpose of saving water. With respect to the stabilization in place of the water washing, a representative example thereof is a multistage countercurrent stabilization treatment described in JP-A-57-8543.

The present invention is described in greater detail below by referring to the Examples, however, the present invention should not be construed as being limited thereto.

### EXAMPLE 1

Emulsion T-1 (Host Tabular Grain Emulsion (Pure Silver Bromide)):

A host tabular grain was prepared as follows in the same system as shown in FIG. 3 of JP-A-2-283837 using the same mixing vessel as shown in FIG. 4 of JP-A-2-283837 (volume of mixing vessel: 0.5 ml).

In a reactor under thorough stirring, 1.0 liter of distilled water, 3 g of low molecular ossein gelatin (average molecular weight: 20,000) and 0.5 g of KBr were added and dissolved. The resulting solution was kept at 35° C. and thereto 10 ml of an aqueous 0.5M silver nitrate solution and 20 ml of a 0.3M KBr solution were added while stirring over 40 seconds (nucleation).

Subsequently, 22 ml of an aqueous 0.8M KBr solution and 300 ml of a 10 wt % trimellited gelatin containing 0.2 mmol of Crystal Habit Control Agent 1 were added and the temperature was elevated to 75° C. over 30 minutes. This solution was further ripened at 75° C. for 5 minutes (ripening).

Thereafter, 1,000 ml of an aqueous 0.60M silver nitrate solution, 50 g of low molecular gelatin (average molecular weight: 20,000), 1,000 ml of an aqueous 0.603M KBr solution and 150 ml of a solution containing 1/50M Crystal Habit Control Agent 1 were added to the mixing vessel by a triple jet method over 56 minutes each at a constant rate. The fine grain emulsion produced in the mixing vessel was continuously added to the reactor. The rotation number of the stirring in the mixing vessel was 2,000 rpm. The stirring blade in the reactor was rotated at 800 rpm and the solution was thoroughly stirred (growth).

During the growth of grains, _{8×10}⁻⁸ mol/mol-Ag of IrCl₆ was added and doped at the time where 70% of silver nitrate was added. Furthermore, before the completion of grain growth, a yellow prussiate of potash solution was added to the mixing vessel. The yellow prussiate of potash was doped to 3% (calculated as the amount of silver added) of the shell part to have a concentration of 3×10⁻⁴ mol/mol-Ag in terms of the local concentration. After the completion of addition, the emulsion was cooled to 35° C. and washed with water by normal flocculation, 50 g of lime-processed ossein gelatin was added and dissolved, the pH was adjusted to 6.5, and thereafter, the emulsion was stored in a cool and dark place. The obtained tabular grain emulsion was an emulsion comprising extremely ultrathin tabular grains having an equivalent-circle diameter of 2.9 μm and an average thickness of 0.026 μm, and in the emulsion, the ratio of tabular grains to the entire projected area of grains in the emulsion was 94%.

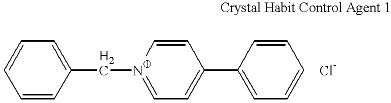

Emulsion E-1 (Present Invention):

To Emulsion T-1 corresponding to 0.3 mol of silver nitrate, 640 ml of distilled water was added and while keeping the temperature at 60° C. and the pAg at 7.0, an aqueous silver nitrate solution and an aqueous potassium iodide solution, which were in the same concentration, were added by a double jet method at 10.5 ml/min for 30 minutes such that the silver amount of the epitaxial phase accounted for 15% of the total silver amount, whereby epitaxial phases were formed on the tabular grain. The obtained emulsion was washed in the same manner as Emulsion T-1 and stored.

Emulsion E-2 (Present Invention):

Emulsion E-2 was prepared in the same manner as Emulsion E-1 except for changing the silver amount of the epitaxial phase to 25% of the total silver amount.

Emulsion E-3 (Comparison):

Emulsion E-3 was prepared in the same manner as Emulsion E-1 except for changing the addition time to 10 minutes.

Emulsion E-4 (Comparison):

Emulsion E-4 was prepared in the same manner as Emulsion E-1 except for changing the temperature at the time of adding the aqueous silver nitrate solution and the aqueous potassium iodide solution to 75° C.

Emulsion E-5 (Comparison):

By attaching silver iodobromide (36 mol % I) as a shell to the outer part of a host tabular grain, the shell of Emulsion T-1 was formed. An aqueous silver nitrate solution and as a mixed halide salt solution, a mixture of KBr and KI were added by a double jet method over 30 minutes to attach silver iodobromide such that the shell amount was 15 mol % of the total silver amount. The deposit of the shell was performed at 60° C. and pBr of 3.6.

Emulsion T-2 (Ultrathin Host Tabular Grain Emulsion):

Emulsion T-2 was prepared in the same manner as Emulsion T-1 except that 0.2 mmol of Crystal Habit Control Agent 1 for use in the ripening and 150 ml of the Crystal Habit Control Agent 1 solution for use in the growth were not added and 100 ml of 2.52M KBr was added before the growth in Emulsion T-1. The obtained tabular grain emulsion was an emulsion comprising ultrathin tabular grains having an equivalent-circle diameter of 2.3 Mm and an average thickness of 0.060 μm, and in the emulsion, the ratio of tabular grains to the entire projected area of grains in the emulsion was 96%.

Emulsion E-6 (Comparison):

Emulsion E-6 was prepared in the same manner as Emulsion E-1 except for using Emulsion T-2.

The shapes and compositions of Emulsions T-1, T-2 and E-1 to E-6 are shown in Table 1.

TABLE 1

| | | | | Ratio of | Difference Between | | |
|---|---|---|---|---|---|---|---|
| | | | | Epitaxy Having | Occupation Area of | | |
| | | Thickness | Silver | Triangular or | Epitaxy in | | |
| | | of Host | Amount of | Hexangular Face | Individual Grains | Composition of | |
| | Host | Tabular | Epitaxial | Shape Occupying | and Average | Epitaxy | |
| Emulsion | Tabular | Grain | Phase | on Main Surface | Occupation Area in | (ratio of | |
| No. | Grain | (μm) | (mol %) | (%) | All Grains | composition*) | |
| E-1 | T-1 | 0.026 | 15 | 38 | ±8 | AgI (100%) | Invention |
| E-2 | T-1 | 0.026 | 25 | 43 | ±9 | AgI (100%) | Invention |
| E-3 | T-1 | 0.026 | 15 | 10 | ±18 | AgBr_{0.65}I_{0.35} (45%) | Comparison |
| | | | | | | AgI (55%) | |
| E-4 | T-1 | 0.026 | 15 | 0 | — | AgBr_{0.68}I_{0.32} (80%) | Comparison |
| | | | | | | AgI (20%) | |
| E-6 | T-2 | 0.060 | 15 | 40 | ±10 | AgI (100%) | Comparison |

*Calculated from the relative intensity of XRD diffraction peak assuming that the coefficient of X-ray absorption is the same.

In Emulsions E-3 and E-4, halogen conversion occurred and an AgI content of 97 mol % or more was not obtained. Particularly, in Emulsion E-4, the phase deposited on the main surface had neither triangular nor hexagonal shape and the deposition was conspicuously occurred on the fringe part, thus, this was a grain not included in the definition of the present invention. The average thickness of epitaxy was 0.011 μm in Emulsion E-1 and 0.013 μm in Emulsion E-2.

To each of Emulsions E-1 to E-6, T-1 and T-2, 1×10⁻³ mol/mol-Ag of Sensitizing Dye 1 was added at 40° C. Subsequently, the temperature was elevated to 55° C., then sodium thiosulfate, potassium chloroaurate and potassium thiocyanate were added, and the chemical sensitization was optimally performed. The obtained emulsion was coated on a cellulose triacetate film support having provided thereon an undercoat layer, in a coverage of 18.5 g/m² in terms of silver. In order to attain good coatability, Surfactant 1 was appropriately added.

Sensitizing Dye 1:

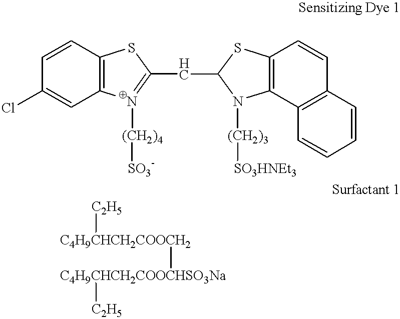

An emulsion and a protective layer were coated on a cellulose triacetate film having provided thereon an undercoat layer under the following conditions to prepare a coated sample.

[Emulsion Coating Conditions]

(1) Emulsion Layer

| | |
|---|---|
| Emulsion | Emulsion of various types |

| | |
|---|---|
| | (as silver: 3.6 × 10⁻² mol/m²) |
| Coupler 1 shown below | (1.5 × 10⁻³ mol/m²) |

Coupler 1:

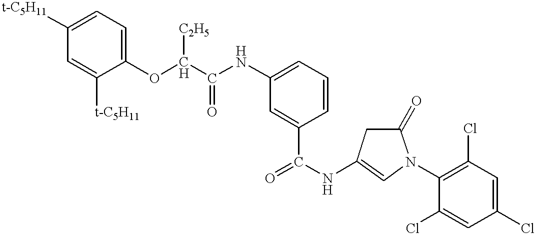

| | |
|---|---|
| Tricresyl phosphate | (1.10 g/m²) |
| Gelatin | (2.30 g/m²) |

(2) Protective Layer

| | |
|---|---|
| 2,4-Dichloro-6-hydroxy-s-triazine | (0.08 g/m²) |
| sodium salt | |
| Gelatin | (1.80 g/m²) |

These samples each was left standing under the conditions of 40° C. and relative humidity of 70% for 14 hours, then exposed through a yellow filter and a continuous wedge for 1/100 seconds, and subjected to the following color development.

[Color Development]

| | | | Processing |
|---|---|---|---|
| | Processing | | Temperature |
| Step | Time | | (° C.) |
| Color development | 2 min | 00 sec | 40 |
| Bleach-fixing | 3 min | 00 sec | 40 |
| Water washing (2) | | 20 sec | 35 |
| Water washing (1) | | 20 sec | 35 |
| Stabilization | | 20 sec | 35 |
| Drying | | 50 sec | 65 |

The composition of each processing solution is shown below.

| | |
|---|---|
| (Color Developer) | (unit: g) |

| | | |
|---|---|---|
| 1-Hydroxyethylidene-1,1-disulfone | 2.0 | |
| diethylenetriaminepentaacetate | | |
| Sodium sulfite | 4.0 | |
| Potassium carbonate | 30.0 | |
| Potassium bromide | 1.4 | |
| Potassium iodide | 1.5 | mg |
| Hydroxylaminesulfuric acid | 2.4 | |
| 4-[N-Ethyl-N-β-hydroxyethylamino]-2- | 4.5 | |
| methylaniline sulfate | | |
| Water to make | 1.0 | liter |
| PH | 10.05 | |

| | |
|---|---|
| (Bleach-Fixing Solution) | (unit: g) |

| | | |
|---|---|---|
| Ammonium ethylenediaminetetraacetato | 90.0 | |
| ferrate dihydrate | | |
| Disodium ethylenediaminetetraacetate | 5.0 | |
| Sodium sulfite | 12.0 | |
| Aqueous ammonium thiosulfate solution | 260.0 | ml |
| (70%) | | |
| Acetic acid (98%) | 5.0 | ml |
| Bleaching Accelerator 1 shown below | 0.01 | mol |

Bleaching Accelerator 1:

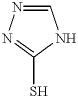

| | | |
|---|---|---|
| Water to make | 1.0 | liter |
| PH | 6.0 | |

(Washing Water)

Tap water was passed through a mixed bed column filled with an H-type cation exchange resin (Amberlite IR-120B, produced by Rhom and Haas) and an OH-type anion exchange resin (Amberlite IR-400, produced by the same company) to reduce the calcium and magnesium ion concentrations each to 3 mg/liter or less and then thereto, 20 mg/liter of sodium isocyanurate dichloride and 1.5 g/liter of sodium sulfate were added.

The resulting solution had a pH of from 6.5 to 7.5.

| (Stabilizing Solution) | (unit:mg) |
|---|---|
| Formalin (37%) | 2.0 ml |
| Polyoxyethylene-p-monononylphenyl | 0.3 |
| ether (average polymerization degree: | |
| 10) | |
| Disodium ethylenediaminetetraacetate | 0.05 |
| Water to make | 1.0 liter |
| PH | 5.0-8.5 |

The sensitivity was determined from the exposure amount in the unit of lux·sec for giving a density 0.1 higher than fog and shown by a relative value of the reciprocal assuming that the sensitivity of Sample T-1 is 100. Also, the same samples were measured on the light absorptivity and the results are shown together in Table 2 as a relative value by taking T-1 as 100.

TABLE 2

| | | | Light | |
|---|---|---|---|---|
| Emulsion | | | Absorptivity | |
| No. | Sensitivity | Fog | (at 427 nm) | |
| T-1 | 100 | 0.10 | 100 | Comparison |
| E-1 | 144 | 0.07 | 510 | Invention |
| E-2 | 163 | 0.06 | 627 | Invention |
| E-3 | 113 | 0.17 | 352 | Comparison |
| E-4 | 125 | 0.16 | 390 | Comparison |
| E-5 | 120 | 0.07 | 160 | Comparison |
| T-2 | 90 | 0.12 | 85 | Comparison |
| E-6 | 132 | 0.11 | 465 | Comparison |

As seen in Table 2, Emulsions E-1 and E-2 of the present invention exhibited high absorptivity for short wave blue light, and low fogging. In Comparative EFmu-lsion E-6, light reflection was increased due to the large thickness of the host tabular grain T-2 as shown in Table 1 and therefore, the sensitivity was lower than that of E-1 or E-2. In Emulsions E-3 and E-4, the number of triangular silver iodide epitaxγ phases deposited was small and therefore, both light absorptivity and sensitivity were low.

A cross-sectional electron microphotograph of each coated sample obtained above was taken in three or more visual fields at a magnification of 3,000 times and an average number of aggregates was measured. As a result, from 40 to 50 aggregates were observed in Emulsions T-1 and T-2, whereas the aggregates were reduced to 5 to 10 pieces in Emulsions E-1 and E-2 of the present invention. By the present invention, improvement was achieved not only in the sensitivity but also in the aggregation state.

### EXAMPLE 2

Emulsion T-3 (Extremely Ultrathin Host Tabular Grain Emulsion (Silver Iodobromide)):

In this Example, the mixing vessel described above in the preparation of Emulsion T-1 was used both in the nucleation and in the grain growth.

To the mixing vessel, 500 ml of an aqueous 0-021M silver nitrate solution and 500 ml of an aqueous 0.028M KBr solution containing 0.1 wt % of low molecular gelatin (average molecular weight: 40,000) were continuously added for 20 minutes. The resulting emulsion was continuously received in a reactor over 20 minutes to obtain 1,000 ml of a nuclear emulsion. At this time, the rotation number of the stirring in the mixing vessel was 2,000 rpm (nucleation).

After the completion of nucleation, 22 ml of a 0.8M KBr solution and 300 ml of a 10 wt % trimellited gelatin containing 0.2 mmol of Crystal Habit Control Agent 1 were added while thoroughly stirring the nuclear emulsion in the reactor and after elevating the temperature to 75° C., the emulsion was left standing for 5 minutes (ripening). Subsequently, 1,000 ml of an aqueous 0.6M silver nitrate solution and 1,000 ml of an aqueous 0.6M KBr solution containing 50 g of low molecular gelatin (average molecular weight: 40,000) and 3 mol % of KI were again added to the mixing vessel each at a constant flow rate for 56 minutes. The fine grain emulsion produced in the mixing vessel was continuously added to the reactor. At this time, the revolution number of stirring in the mixing vessel was 2,000 rpm. At the same time, 150 ml of a solution containing 1/50M Crystal Habit Control Agent 1 was continuously added to the reactor at a constant flow rate. The stirring blade in the reactor was rotated at 800 rpm and the emulsion was thoroughly stirred (grain growth).

During the growth of grains, 8×10⁻⁸ mol/mol-Ag of IrCl₆ was added and doped at the time where 70% of silver nitrate was added. Furthermore, before the completion of grain growth, a yellow prussiate of potash solution was added to the mixing vessel. The yellow prussiate of potash was doped to 3% (calculated as the amount of silver added) of the shell part to have a concentration of 3×10⁻⁴ mol/mol-Ag in terms of the local concentration. After the completion of addition, the emulsion was cooled to 35° C. and washed with water by normal flocculation, 50 g of lime-processed ossein gelatin was added and dissolved, the pH was adjusted to 6.5, and thereafter, the emulsion was stored in a cool and dark place. The obtained tabular grain emulsion was an emulsion comprising extremely ultrathin tabular grains having an equivalent-circle diameter of 3.0 μm and an average thickness of 0.023 μm, and in the emulsion, the ratio of tabular grains to the entire projected area of grains in the emulsion was 96%.

Emulsion E-7 (Present Invention):

To Emulsion T-3 corresponding to 0.3 mol of silver nitrate, 640 ml of distilled water was added and while keeping the temperature at 60° C., an aqueous silver nitrate solution and an aqueous potassium iodide solution, which were in the same concentration, were added by a double jet method for 60 minutes while keeping the pBr to 4.0 such that the silver amount of the epitaxial phase accounted for 20% of the total silver amount. From the initiation to the completion of addition, the flow rate was accelerated to 10 times higher. The obtained emulsion was washed in the same manner as Emulsion T-1 and stored.

Emulsion E-8 (Present Invention):

Emulsion E-8 was prepared in the same manner as Emulsion E-7 except for changing the silver amount of the epitaxial phase to 10% of the total silver amount.

Emulsion E-9 (Comparison):

Emulsion E-9 was prepared in the same manner as Emulsion E-7 except for changing the temperature at the time of adding the aqueous silver nitrate solution and the aqueous potassium iodide solution to 75° C.

Emulsion T-4 (Ultrathin Host Tabular Grain Emulsion):

Emulsion T-4 was prepared in the same manner as Emulsion T-3 except that 0.2 mmol of Crystal Habit Control Agent 1 was incorporated into 500 ml of the aqueous 0.028M KBr solution containing 0.1 wt % of low molecular gelatin (average molecular weight: 40,000) at the nucleation and the addition of 0.2 mmol of Crystal Habit Control Agent 1 after the nucleation was not performed in Emulsion T-3. The obtained tabular grain emulsion was an emulsion comprising ultrathin tabular grains having an equivalent-circle diameter of 2.1 μm and an average thickness of 0.067 μm, and in the emulsion, the ratio of tabular grains to the entire projected area was 82%.

Emulsion E-10 (Comparison):

Emulsion E-10 was prepared in the same manner as Emulsion E-8 except for using Emulsion T-4.

The emulsions obtained are shown together in Table 3.

TABLE 3

| | | | | Ratio of | Difference Between | | |
|---|---|---|---|---|---|---|---|
| | | | | Epitaxy Having | Occupation Area of | | |
| | | Thickness | Silver | Triangular or | Epitaxy in | | |
| | | of Host | Amount of | Hexangular Face | Individual Grains | Composition of | |
| | Host | Tabular | Epitaxial | Shape Occupying | and Average | Epitaxy | |
| Emulsion | Tabular | Grain | Phase | on Main Surface | Occupation Area in | (ratio of | |
| No. | Grain | (μm) | (mol %) | (%) | All Grains | composition*) | |
| E-7 | T-3 | 0.023 | 20 | 42 | ±9 | AgI (98%) | Invention |
| E-8 | T-3 | 0.023 | 10 | 37 | ±6 | AgI (100%) | Invention |
| E-9 | T-3 | 0.023 | 20 | 0 | — | AgBr_{0.65}I_{0.35} (55%) | Comparison |
| | | | | | | AgI (45%) | |
| E-10 | T-4 | 0.067 | 20 | 45 | ±21 | AgI (100%) | Comparison |

*Calculated from the relative intensity of XRD diffraction peak assuming that the coefficient of X-ray absorption is the same.

Particularly, in Emulsion E-9, the phase deposited on the main surface had neither triangular nor hexagonal shape and the deposition was conspicuously occurred on the fringe part, thus, this was a grain not included in the definition of the present invention. The average thickness of epitaxy was 0.012 μm in Emulsion E-7 and 0.007 μm in Emulsion E-8.

The thus-obtained Emulsions T-3, T-4 and E-7 to E-10 each was exposed and developed in the same manner as in Example 1. The results are shown in Table 4. Also, the same samples were measured on the light absorptivity and the results are shown together in Table 4 as a relative value by taking T-3 as 100.

TABLE 4

| | | | Light | |
|---|---|---|---|---|
| Emulsion | | | Absorptivity | |
| No. | Sensitivity | Fog | (at 427 nm) | |
| T-2 | 100 | 0.15 | 100 | Comparison |
| E-7 | 165 | 0.13 | 575 | Invention |
| E-8 | 145 | 0.14 | 398 | Invention |
| E-9 | 128 | 0.19 | 375 | Comparison |
| T-4 | 93 | 0.16 | 78 | Comparison |
| E-10 | 148 | 0.15 | 530 | Comparison |

As seen in Table 4, Emulsions E-7 and E-8 of the present invention exhibited good results all in sensitivity, fog and light absorptivity.

The aggregation state of each coated sample was observed in the same manner as in Example 1, as a result, similarly to the results in Example 1, the aggregation state was greatly improved in Emulsions E-7 and E-8 of the present invention as compared with Host Tabular Grain Emulsions T-3 and T-4.

### EXAMPLE 3

Emulsion E-7 obtained in Example 2 was chemically sensitized in an optimal manner and then spectrally sensitized. The resulting emulsion was used as the emulsion for the third layer in the light-sensitive material of Sample 201 in Example 2 of JP-A-9-146237 and the light-sensitive material was processed in the same manner as in the Example of JP-A-9-146237. Then, good results were obtained

### EXAMPLE 4

Emulsion E-7 obtained in Example 2 was chemically sensitized in an optimal manner and then spectrally sensitized. The resulting emulsion was used as the emulsion for the third layer in the light-sensitive material of Sample 110 in Example 1 of JP-A-10-20462 and the light-sensitive material was processed in the same manner as in the Example of JP-A-10-20462 Then, good results were obtained.

### EXAMPLE 5

Emulsion T-5 (Ultrathin Host Tabular Grain Emulsion):

In this example, the nucleation was performed using a reactor and the grain growth was performed by adding fine grains prepared in a mixing vessel described in the preparation of Emulsion T-2 to the reactor. In a reactor, 1.0 liter of water, 0.5 g of ossein gelatin (methionine content: 5 μm/g) subjected to an oxidation treatment and 0.38 g of KBr were added and dissolved and to the reactor containing this solution kept at 20° C., 20 ml of 0.29 M aqueous silver nitrate solution and 20 ml of an aqueous KBr solution were added while stirring over 40 seconds (nucleation).

The temperature was elevated from 20° C. to 75° C. over 29 minutes and the solution was allowed to stand at this temperature for 2 minutes. In the way of elevating the temperature, 495 ml of an aqueous 10 wt % trimellited gelatin solution and KBr were added to adjust the pBr within the reactor to 2.1. Furthermore, 3 minutes after the completion of nucleation, 10 ml of 0.02M Crystal Habit Control Agent 2 was added to the reactor (ripening).

Thereafter, to a mixing vessel, 942 ml of a 0.53M aqueous silver nitrate solution, 942 ml of a 0.59M aqueous KBr solution containing 5 wt % of low molecular gelatin (average molecular weight: 20,000), and 150 ml of an aqueous 0.02M Crystal Habit Control Agent 2 solution were added each in a constant amount over 42 minutes. The fine grain emulsion prepared in the mixing vessel was continuously added to the reactor (growth).

The obtained ultrathin tabular grains had an average thickness of 0.036 nm, a coefficient of variation in the tabular grain thickness of 86%, and an average equivalent-circle diameter of 1.0 nm. The coefficient of variation is a value obtained by dividing the standard deviation of the tabular grain thickness by an average tabular grain thickness and multiplying the value obtained by 100.

Crystal Habit Control Agent 2:

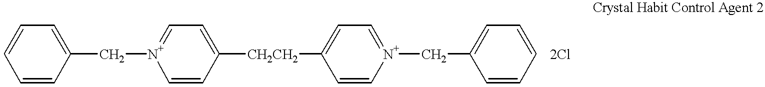

Emulsion E-11 (Comparison):

Emulsion E-11 was prepared in the same manner as Emulsion E-1 except for using Emulsion T-5.

Emulsion T-6 (Ultrathin Host Tabular Grain Emulsion):

Emulsion T-6 was prepared in the same manner as Emulsion T-5 except for adding 200 ml of a 10 wt % solution of high molecular weight ossein gelatin (components having a molecular weight of 300,000 or more: 16.2%) to the reactor before the growth of tabular grains. The obtained ultrathin tabular grains had an average thickness of 0.033 nm, a coefficient of variation in the tabular grain thickness of 18% and an average equivalent-circle diameter of 1.3 nm.

Emulsion E-12 (Invention):

Emulsion E-12 was prepared in the same manner as Emulsion E-1 except for using Emulsion T-6.

The grain shape of the thus-obtained Emulsions 11 and E-12 is shown in Table 5.

TABLE 5

| | | | | | Difference | | |
|---|---|---|---|---|---|---|---|
| | | | | | Between | | |
| | | | | Ratio of | Occupation Area | | |
| | | Thickness of | | Epitaxy Having | of Epitaxy in | | |
| | | Host Tabular | Silver | Triangular or | Individual | | |
| | | Grain (μm) | Amount of | Hexangular Face | Grains and | Composition | |
| | Host | [coefficient | Epitaxial | Shape Occupying | Average | of Epitaxy | |
| Emulsion | Tabular | of | Phase | on Main surface | Occupation Area | (ratio of | |
| No. | Grain | variation, %] | (mol %) | (%) | in All Grains | composition*) | |
| E-11 | T-5 | 0.036 [86] | 15 | 35 | ±15 | AgI (100%) | Comparison |
| E-12 | T-6 | 0.033 [18] | 15 | 37 | ±6 | AgI (100%) | Invention |

* Calculated from the relative intensity of XRD diffraction peak assuming that the coefficient of X-ray absorption is the same.

The emulsions shown in Table 5 each was exposed and developed in the same manner as in Example 1. As a result, in Emulsion E-12, good results were obtained in all of sensitivity, fog and light absorptivity and particularly, the graininess thereof was found to be superior to Emulsion E-11.

### EXAMPLE 6

Emulsion T-7 (Thin Host Tabular Grain Emulsion (Having Dislocation)):

To a reactor, 1,205 ml of an aqueous gelatin solution (containing 0.6 g of deionized alkali-treated ossein gelatin having a methionine content of about 3 μmol/g and 0.47 g of KBr) was charged and kept at a temperature of 20° C. While stirring this solution, Solution Ag-1 (containing 5 g of silver nitrate in 100 ml) and Solution X-1 (containing 3.5 g of KBr in 100 ml) were added each in 20 ml at 30 ml/min by a double jet method. After stirring for 1 minute, 14 ml of a 30% aqueous KBr solution was added and the temperature was elevated to 75° C. over 24 minutes. Immediately after the initiation of temperature elevation, 350 ml of an aqueous dispersion medium solution containing 35 g of trimellited gelatin was added. Furthermore, immediately after the addition of the gelatin, 10 ml of 1/50M (111) Crystal Habit Control Agent 1 was added. After the elevation of temperature to 75° C., the mixture was allowed to stand for 2 minutes and thereto, 200 ml of an aqueous dispersion medium solution containing 20 g of trimellited gelatin and 10 ml of an aqueous 3,6-dithia-1,8-octanediol solution (1.0 wt %) were added. 10 Minutes after the completion of the addition, 9 ml of Solution Ag-2 (containing 20.4 g of silver nitrate in 100 ml) was added by accelerating the flow rate in 0.32 ml/min increments from the flow rate of 1.0 ml/min at the initiation of addition. During this time, Solution X-2 (containing 16.6 g of KBr in 100 ml) was simultaneously added by a CDJ (controlled double jet) method so as to keep the pBr at 2.5. Furthermore, 10 seconds after the initiation of the addition of Solution Ag-2, fine grain AgI emulsion prepared by simultaneously adding 70.7 ml of Solution Ag-3 (containing 1.7 g of silver nitrate in 100 ml) and Solution X-3 (containing 1.7 g of KI and 5.0 g of deionized alkali-treated low molecular weight gelatin (average molecular weight: 20,000) in 100 ml) each at 15.7 ml/min to a 0.5 ml-volume mixing vessel under well stirring described in JP-A-10-43570 and mixing the solutions, was continuously added to the reactor. At this time, the stirring and revolution number of the mixing vessel was 2,000 rpm. 2 Minutes after the completion of addition of Solution A-2, 493 ml of Solution Ag-4 (containing 20.4 g of silver nitrate in 100 ml) was added while accelerating the flow rate in 0.6 ml/min increments from the flow rate of 4.3 ml/min at the initiation of addition. During this time, Solution X-4 (containing 16.6 g of KBr in 100 ml) was simultaneously added by CDJ (controlled double jet) method so as to keep the pBr at 2-5. At the time of adding Solution Ag-4, 398 ml of 1/125M (111) Crystal Habit Control Agent 1 was simultaneously added while accelerating the flow rate in 0.6 ml/min increments from the flow rate of 1.5 ml/min at the initiation of addition. 1 Minute after the completion of addition of Solution Ag-4, the temperature was lowered to 35° C., then sulfuric acid was added to adjust the pH to 3.9, and soluble salts and the like were removed by flocculation method. Thereafter, the temperature was again elevated to 50° C., 75 g of lime-processed ossein gelatin and 130 ml of filtered water were added to redisperse the emulsion, and then NaOH and KBr were added to adjust the pH and pAg to 5.5 and 8.6, respectively. The thus-obtained (111) tabular grains had an average equivalent-circle diameter of 1.46 μm and an average grain thickness of 0.058 μm. The ratio of the projected area of (111) tabular grains to the entire projected area of all grains was 96%.

Emulsion E-13 (Comparison):

To Emulsion T-7 corresponding to 0.5 mol of silver nitrate, 640 ml of distilled water was added and thereto, while keeping the temperature at 65° C. and the pAg at 7.02, an aqueous silver nitrate solution and an aqueous potassium iodide solution having the same concentration were added in twice segments of 10-minutes growth such that the silver amount of the epitaxial phase was 18% of the total silver amount. In the first segment, the addition rate of the aqueous silver nitrate solution was accelerated to 3 5 to 17.5 ml/min and during this time, the addition rate of KI was accelerate to 5 to 25 ml/min. In the second segment, the addition rate of the aqueous silver nitrate solution to 17.5 to 35 ml/min and during this time, the addition rate of KI was accelerated to 25 to 50 ml/min. The obtained emulsion was washed and stored in the same manner as Emulsion T-1.

Emulsion T-8 (Thin Host Tabular Grain Emulsion (Having No Dislocation)):

Emulsion T-8 was prepared in the same manner as Emulsion T-7 except for not adding fine AgI grains formed using Solution Ag-3 and Solution X-3. The obtained (111) tabular grains had an average equivalent-circle diameter of 1.59 μm and an average grain thickness of 0.050 μm. The ratio of the projected area of (111) tabular grains to the entire projected area of all grains was 98%.

Emulsion E-14 (Comparison):

Emulsion E-14 was prepared in the same manner as Emulsion E-11 except for using Emulsion T-8. Emulsion T-9 (ultrathin host tabular grain emulsion (having dislocation)):

To a reactor, 1,205 ml of an aqueous gelatin solution (containing 0.6 g of deionized alkali-treated ossein gelatin having a methionine content of about 3 μmol/g and 0.47 g of KBr) was charged and kept at a temperature of 20° C. While stirring this solution, Solution Ag-1(containing 5 g of silver nitrate in 100 ml) and Solution X-1 (containing 3.5 g of KBr in 100 ml) were added each in 20 ml at 30 ml/min by a double jet method. After stirring for 1 minute, 14 ml of a 30% aqueous 30% KBr solution was added and the temperature was elevated to 75° C. over 24 minutes. Immediately after the initiation of temperature elevation, 350 ml of an aqueous dispersion medium solution containing 35 g of trimellited gelatin was added. Furthermore, immediately after the addition of the gelatin, 10 ml of 1/50M (111) Crystal Habit Control Agent 1 was added. After the elevation of temperature to 75° C., the mixture was allowed to stand for 2 minutes and thereto, 200 ml of an aqueous dispersion medium solution containing 20 g of trimellited gelatin and 10 ml of an aqueous 3,6-dithia-1,8-octanediol solution (1.0 wt %) were added. 10 Minutes after the completion of the addition, 9 ml of Solution Ag-2 (containing 20.4 g of silver nitrate in 100 ml) was added by accelerating the flow rate in 0.32 ml/min increments from the flow rate of 1.0 ml/min at the initiation of addition. During this time, Solution X-2 (containing 16.6 g of KBr in 100 ml) was simultaneously added by a CDJ (controlled double jet) method so as to keep the pBr at 2.5. Furthermore, 10 seconds after the initiation of the addition of Solution Ag-2, fine grain AgI emulsion prepared by simultaneously adding 70.7 ml of Solution Ag-3 (containing 1.7 g of silver nitrate in 100 ml) and Solution X-3 (containing 1.7 g of KI and 5.0 g of deionized alkali-treated low molecular weight gelatin (average molecular weight: 20,000) in 100 ml) each at 15.7 ml/min to a 0.5 ml-volume mixing vessel under well stirring described in JP-A-10-43570 and mixing the solutions, was continuously added to the reactor. At this time, the stirring and revolution number of the mixing vessel was 2,000 rpm. 2 Minutes after the completion of addition of Solution A-2, fine grain AgBr emulsion formed by simultaneously adding 942 ml of Solution Ag-4 (containing 9.1 g of silver nitrate in 100 ml) and 942 ml of Solution X-3 (containing 7.0 g of KBr and 5.0 g of deionized alkali-treated low molecular weight gelatin (average molecular weight: 20,000) in 100 ml) each at 22.5 ml/min to the mixing vessel and mixing the solutions, was again continuously added to the reactor. At this time, the stirring and revolution number of the mixing vessel was 2,000 rpm. Furthermore, at the time of adding the fine grain emulsion, 213.5 ml of 0.013M (111) Crystal Habit Control Agent 1 was simultaneously added at 5.1 ml/min. During the addition of the fine grain emulsion, the reactor was constantly kept at a temperature of 75° C. and a pBr of 2.5. 1 Minute after the completion of the addition of the fine grain emulsion, the temperature was lowered to 35° C., then sulfuric acid was added to adjust the pH to 3.9, and soluble salts and the like were removed by flocculation method. Thereafter, the temperature was again elevated to 50° C., 75 g of lime-processed ossein gelatin and 130 ml of filtered water were added to redisperse the emulsion, and then NaOH and KBr were added to adjust the pH and pAg to 5.5 and 8.6, respectively. The thus-obtained (111) tabular grains had an average equivalent-circle diameter of 2.23 μm and an average grain thickness of 0.034 μm. The ratio of the projected area of (111) tabular grains to the entire projected area of all grains was 88%.

Emulsion E-15 (Invention):

Emulsion E-15 was prepared in the same manner as Emulsion E-11 except for using Emulsion T-9.

Emulsions E-13 to E-15 all had the same grain shape, where an epitaxial phase having a triangular or hexangular face shape was deposited on the main surface. By the X-ray diffraction analysis, the deposited epitaxial phase had an AgI content of 97 mol % or more in any Emulsion. These Emulsions each was subjected to optimum chemical sensitization and spectral sensitization with Sensitizing Dye 2 shown below and then exposed and developed in the same manner as in Example 1. The sensitivity was obtained from the exposure amount (lux sec) necessary for giving a density of (fog+0.1) and expressed as a relative value of the logarithm of reciprocal assuming that the sensitivity of Sample T-7 was 100. The results obtained are shown in Table 6. Not only the sensitivity was elevated by the AgI epitaxial phase but also the sensitivity was more elevated by the introduction of dislocation into the host tabular grain. Furthermore, the residual color due to the dye after the development was greatly improved by the use of Sensitizing Dye 2.

Sensitizing Dye 2:

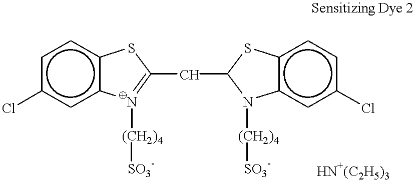

TABLE 6

| | | | Light | |
|---|---|---|---|---|
| Emulsion | | | Absorptivity | |
| No. | Sensitivity | Fog | (at 427 nm) | |
| T-7 | 100 | 0.15 | 100 | Comparison |
| E-13 | 155 | 0.13 | 471 | Comparison |
| T-8 | 75 | 0.14 | 110 | Comparison |
| E-14 | 148 | 0.13 | 450 | Comparison |
| T-9 | 138 | 0.14 | 121 | Comparison |
| E-15 | 199 | 0.11 | 499 | Invention |

According to the present invention, an ultrathin tabular grain emulsion exhibiting highly efficient blue absorption, ensuring good properties in sensitivity and fogging, and having a high iodide epitaxial phase was obtained. Moreover, in the present invention, the aggregation which had been heretofore a problem of ultrathin tabular grain emulsions, was greatly improved.

While the invention has been described in detail and with reference to specific embodiments thereof, it will be apparent to one skilled in the art that various changes and modifications can be made therein without departing from the spirit and scope thereof.

What is claimed is:

1. A silver halide emulsion comprising silver halide grains of which 70% or more of the total projected area is occupied by tabular grains, said tabular grain having main surfaces of {111} face and a thickness of 0.04 μm or less and being joined with an epitaxial phase comprising silver halide containing 97 mol % or more of silver iodide.

2. The silver halide emulsion as claimed in claim 1, wherein at least 60% of said epitaxial phase contains 97 mol % or more of silver iodide.

3. The silver halide emulsion as claimed in claim 1, wherein said epitaxial phase occupies at least 10% of the total silver amount.

4. The silver halide emulsion as claimed in claim 1, wherein the area occupied by the epitaxial phase joined to the main surface of said tabular grain is within ±10% of the average occupation area in all grains.

5. The silver halide emulsion as claimed in claim 1, wherein said tabular grain has an equivalent-circle diameter of at least 0.7 μm.

6. The silver halide emulsion as claimed in claim 1, wherein the coefficient of variation in the thickness of said tabular grains is less than 40% among grains.

7. The silver halide emulsion as claimed in claim 1, wherein [1] said tabular grain comprises core and shell, [2] the shell contains one or more dislocation line starting from the interface between core and shell and reaching the edge or corner of the tabular grain, and [3] the amount of silver used for the formation of core is from 0.1 to 10% of the entire amount of silver used for forming the grain.

8. The silver halide emulsion as claimed in claim 1, wherein said tabular grain comprises at least 50 mol % of silver chloride.

9. The silver halide emulsion as claimed in claim 1, wherein said tabular grain comprises at least 70 mol % of silver bromide.

10. The silver halide emulsion as claimed in claim 1, wherein in the preparation of said tabular grains, at least one compound represented by formula (I), (II) or (III) is absent at the nucleation but is present at the ripening and growing: 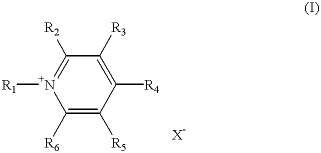
(wherein R₁ represents an alkyl group, an alkenyl group or an aralkyl group, R₂, R₃, R₄, R₅ and R₆ each represents a hydrogen atom or a substituent, each pair R₂ and R₃, R₃ and R₄, R₄ and R₅, and R₅ and R₆ may form a condensed ring, provided that at least one of R₂, R₃, R₄, R₅ and R₆ represents an aryl group, and X⁻ represents an anion) 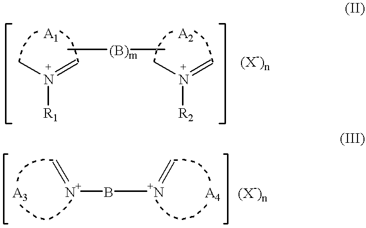
wherein A₁, A₂, A₃ and A₄, which may be the same or different, each represents a nonmetallic atom group necessary for completing a nitrogen-containing heterocyclic ring, B represents a divalent linking group, m represents 0 or 1, R₁ and R₂ each represents an alkyl group, n represents 0, 1 or 2, and X⁻ represents an anion.

11. The silver halide emulsion as claimed in claim 1, wherein said tabular grains are formed by providing a mixing vessel outside a reactor in which nucleation and/or grain growth of said tabular grains takes place, feeding an aqueous solution of an aqueous silver salt and an aqueous solution of aqueous halide into said mixing vessel to form silver halide fine grains, and immediately feeding the formed fine grains into said reactor to cause nucleation and/or grain growth of silver halide grains in the reactor.

12. The silver halide emulsion as claimed in claim 1, wherein said silver halide grain is spectrally sensitized by a dye represented by formula (S): 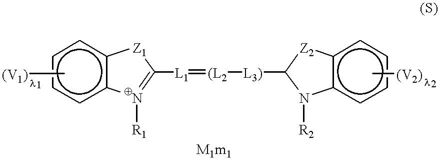
wherein Z₁ and Z₂ each represents a sulfur atom, a selenium atom, an oxygen atom or a nitrogen atom, V₁ and V₂ each represents a monovalent substituent, provided that V₁ and V₂ each is not combined with an aromatic group to form a condensed ring or two or more adjacent substituents V₁ or V₂ are not combined to form a condensed ring, λ₁ and λ₂ each represents 0, 1, 2 or 3, L₁, L₂ and L₃ each represents a methine group, R₁ and R₂ each represents an alkyl group, n₁ represents 0, 1 or 2, m represents a number of 0 or more necessary for neutralizing the electric charge of the molecule, and M₁ represents a charge balancing counter ion.
